(19) United States
(12) Patent Application Publication
(10) Pub. No.: US 2025/0068444 A1
(43) Pub. Date: Feb. 27, 2025

(54) SYSTEMS AND METHODS FOR LOADING AGENTS INTO VIRTUAL MACHINES

(71) Applicant: Cloud Linux Software, Inc., Estero, FL (US)

(72) Inventors: Igor SELETSKIY, Palo Alto, CA (US); Nikita Popov, Perm (RU)

(21) Appl. No.: 18/455,995

(22) Filed: Aug. 25, 2023

(51) Int. Cl. G06F 9/455; G06F 9/445

(52) U.S. Cl. CPC G06F 9/45504; G06F 9/445

(57) ABSTRACT

Disclosed herein are systems and methods for loading an agent into a virtual machine. In one aspect, a method may include receiving a path to an agent and an options string, wherein the agent comprises a set of classes built to perform an action, resolving, using a process identifier, an identity of a first process comprising a virtual machine instance that has not been augmented by the agent on a host. The method may include performing augmentation on the process by: changing an original identity of a current operating system process to the first identity in response to determining that the current operating system process is privileged, injecting the agent into the virtual machine instance with the path and the options string as arguments of an injection, and reinstating the original identity of the current operating system process.

### FIELD OF TECHNOLOGY

The present disclosure relates to the field of virtual machines, and, more specifically, to systems and methods for loading agents into virtual machines.

### BACKGROUND

The reference Java Virtual Machine (JVM) implementation, which is named HotSpot and is shipped with the Open Java Development Kit (OpenJDK) package on some platforms, provides the feature of executing various commands on a launched JVM instance through the Java attach mechanism. Among these commands is one that loads a native library into the JVM instance at run-time and calls its «Agent_OnAttach» function as the entry point. The library then initializes itself, communicates with the JVM through Java Native Interface (JNI) and Java Virtual Machine Tool Interfaces (JVM TIs), and optionally, installs hooks and provides handlers for native methods.

One of the libraries that may be loaded this way is provided by a Java vendor. It is called an «instrument». This library is capable of loading arbitrary Java code comprising a Java agent into a Java process. Running in the context of that process, such code can access static or member fields of the running Java application if it is allowed by access control checks. Moreover, the library provides the code with a «java.lang.instrument.Instrumentation» object through which the code can modify any Java class to some extent at run-time without the need to restart the running application.

This feature is the main building block for live patching of Java applications in which parts of the code of a Java application are replaced while the application keeps running. The live patching itself helps to decrease the downtime of an affected application, thereby avoiding potential financial losses for a business depending on the application. Such an application may have a significant startup overhead which executes when a system administrator restarts the application after patching it conventionally.

A system utilizing the agent loading facility to either live patch Java applications or perform some other actions on them needs both the method of finding such applications on a host and the method of preventing repeat agent injections. In addition, if the system wants to support a specific development kit such as the OpenJDK 8, some idiosyncrasies of the version on the Unix platform must be taken into account.

### SUMMARY

In one exemplary aspect, the techniques described herein relate to a method of loading an agent into a virtual machine, the method including: receiving a path to an agent and an options string, wherein the agent includes a set of classes built to perform an action; resolving, using a process identifier, an identity of a first process including a virtual machine instance that has not been augmented by the agent on a host; performing augmentation on the process by: changing an original identity of a current operating system process to the first identity in response to determining that the current operating system process is privileged; injecting the agent into the virtual machine instance with the path and the options string as arguments of an injection; reinstating the original identity of the current operating system process.

In some aspects, the techniques described herein relate to a method, wherein resolving the identity includes: retrieving a status file associated with the process identifier; parsing the status file to determine an effective user identifier and an effective group identifier, wherein the first identity includes the effective user identifier and the effective group identifier.

In some aspects, the techniques described herein relate to a method, further including identifying the virtual machine instance by: retrieving a list of virtual machine descriptors wherein each descriptor designates a process running a virtual machine; and identifying the virtual machine instance in the list.

In some aspects, the techniques described herein relate to a method, wherein performing the augmentation on the process includes executing a Java attach mechanism.

In some aspects, the techniques described herein relate to a method, further including: determining whether the current operating system process is privileged; setting a real user identifier and a group identifier to those of a root user to facilitate subsequent dropping and restoring of the privilege.

In some aspects, the techniques described herein relate to a method, wherein the first identity belongs to both the first process and a second process, further including: populating a hash table including the first identity and process identifiers for the first process and the second process, wherein keys of the hash table are identities and values of the hash table are lists of process identifiers; grouping the first process and the second process based on matching identities.

In some aspects, the techniques described herein relate to a method, further including: querying a respective identity of each process with operating system facilities; and placing a respective identifier of each process in the hash table.

In some aspects, the techniques described herein relate to a method, further including: defining objects embedding operating system-specific information to distinguish identities; using the objects as keys inside hash tables; and altering a list of processes without modifying the hash table.

It should be noted that the methods described above may be implemented in a system comprising a hardware processor. Alternatively, the methods may be implemented using computer executable instructions of a non-transitory computer readable medium.

In some aspects, the techniques described herein relate to a system for loading an agent into a virtual machine, including: at least one memory; at least one hardware processor coupled with the at least one memory and configured, individually or in combination, to: receive a path to an agent and an options string, wherein the agent includes a set of classes built to perform an action; resolve, using a process identifier, an identity of a first process including a virtual machine instance that has not been augmented by the agent on a host; perform augmentation on the process by: changing an original identity of a current operating system process to the first identity in response to determining that the current operating system process is privileged; injecting the agent into the virtual machine instance with the path and the options string as arguments of an injection; reinstating the original identity of the current operating system process.

In some aspects, the techniques described herein relate to a non-transitory computer readable medium storing thereon computer executable instructions for loading an agent into a virtual machine, including instructions for: receiving a path to an agent and an options string, wherein the agent includes a set of classes built to perform an action; resolving, using a process identifier, an identity of a first process including a virtual machine instance that has not been augmented by the agent on a host; performing augmentation on the process by: changing an original identity of a current operating system process to the first identity in response to determining that the current operating system process is privileged; injecting the agent into the virtual machine instance with the path and the options string as arguments of an injection; reinstating the original identity of the current operating system process.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for loading agents into virtual machines.

FIG. 2 illustrates a flow diagram of a system loading agents into Java Virtual Machines coexisting on a system host.

FIG. 3 illustrates a flow diagram of an analyzer configured to transform a list of descriptors of virtual machines into a hash table with identities as keys and lists of process identifiers as values.

FIG. 4 illustrates a flow diagram of a method for mapping a process identifier onto an identity on the Linux platform.

FIG. 5 illustrates a flow diagram of a method for adding a pair including a process identifier and an identity into the hash table.

FIG. 6 illustrates a flow diagram of an upper layer of the agent loading component.

FIG. 7 illustrates a flow diagram of a middle layer of the agent loading component.

FIG. 8 illustrates a flow diagram of a bottom layer of the agent loading component.

FIG. 9 is a flow diagram illustrating a method for loading agents into virtual machines.

FIG. 10 presents an example of a general-purpose computer system on which aspects of the present disclosure may be implemented.

### DETAILED DESCRIPTION

Exemplary aspects are described herein in the context of a system, method, and computer program product for loading agents into virtual machines (VMs). Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes facilitating techniques to load agents into VMs. Among these techniques is a method for scanning a host for existing VM instances and a method for checking if a VM instance has already been augmented with an agent, and injecting the agent into that instance if not. Techniques to overcome some deficiencies of the attach mechanism of specific open development kits (e.g., OpenJDK 8 on a Unix-like operating system) are also proposed. These techniques extend the applicability of systems that are described in the current disclosure to a broader range of open development kit versions while preserving the correct operation with more recent ones.

In the context of the current disclosure, augmentation of a VM instance (or process) with an agent is the same as the injection of the agent into the VM instance. These phrases are interchangeable. The term “process” is used to denote a software program with all its state at run-time. On the other hand, a JVM instance is a process running a Java application. In that regard, the generic term “process” subsumes the specific term “JVM instance.” An agent (e.g., a Java agent) includes an arbitrary application (e.g., a Java application) with the additional benefit of having an “instrumentation” object through which modifications to running code (e.g., Java code) in the current process can be made. It is up to a developer to implement a specific logic for the agent. One of the possible use cases involves live-patching of the Java code.

In some aspects, the virtual machines are Java virtual machines (JVMs), the processes are Java processes, and the host is a Java host. Accordingly, to search a host for running Java processes, a supplementary package «com.sun.tools.attach», which is not part of the standard Java Runtime Environment (JRE) for the OpenJDK 8, may be used. This package includes the «VirtualMachine» class that defines the static method named «list» for scanning. This method returns the list of virtual machine descriptors where each descriptor designates one process running a Java application. In the current disclosure, the “JVM” or “JVM instance” refers to an OS process in which the implementation of the Java Virtual Machine (e.g., HotSpot) is running. The Java Virtual Machine features an interpreter of Java code, which is able to execute JVM instructions that comprise a Java application. In other words, the term “JVM” relates to the term “Java application” as the hardware processor relates to the native code (which is the result of the compilation of a C program, for instance).

A system may attach to any process from this list provided that a target process has not exited. For example, on Linux, a process terminates when it executes the ‘exit’ system call. After that, the process is terminated. Special care should be taken to access the «com.sun.tools.attach» package on the OpenJDK 8 as it is not reachable with the standard class path. Nonetheless, various solutions may be accommodated to use that package. For example, one solution involves installing the Java Development Kit (JDK), locating the «tools.jar» file that is a part of the JDK, and adding the file to the application's class path both at compile- and run-times.

Once a JVM instance, or a Java process, has been found at the previous step and its descriptor is available to a system managing Java agents, another static method of the «VirtualMachine» class, that is named «attach», may be invoked to connect to that process through the attach mechanism. This method comes in two approaches. One approach accepts a virtual machine descriptor and the other approach takes a process identifier as a string. Considering that a process identifier may be extracted from a virtual machine descriptor, these two approaches may be used interchangeably. The result of a method invocation is a virtual machine handle that may be used to execute commands on the target JVM instance.

Using the virtual machine handle of a Java process, the system may invoke a member method named «loadAgent» on the handle with a file system path to a JAR file constituting a Java agent and a string argument in which any options are passed to the Java agent. As a result, this Java agent is loaded into the target Java process and its «agentmain» method is invoked in the context of that process. The method gets a special «java.lang.instrument.Instrumentation» object and an options string as arguments. The options string refers to the second argument that is mentioned previously (i.e., a string argument in which options are passed to a Java agent). The semantics and the exact content of this argument are up to the Java agent, and a developer may pass the necessary information to the agent. For example, the prototype of a live-patching agent requires a path to a directory with patches. This piece of data can be supplied to the agent via the options string.

The manifest file of the loaded JAR file must include a specific entry (e.g., labeled «Agent-Class:») that indicates the class defining the «agentmain» method within the JAR file. Additionally, entries declaring required capabilities for the agent may be included in the manifest file.

One precaution that is taken is to not load a single agent twice because the agent's logic may not be reentrant. An exemplary way of ensuring that is to use the system properties of a Java application running in a target process. With the virtual machine handle of that process, it is possible to get the properties table of the target Java application through an invocation of the «getSystemProperties» method on the handle. If a designated property exists in the retrieved table, then the agent has already been loaded provided that the agent's code has set this property in the local properties table.

One aspect of the internal logic of the attach mechanism is security checks implemented on the Unix platform. These security checks verify that either the effective user and group (EUID, EGID) parameters of a system connecting through the attach mechanism match the ones of a running Java process or the EUID of such a system is the root. The OpenJDK 8 version is distinct in that regard as its security checks are narrowed to only matching the EUID and EGID parameters of a connecting system to the corresponding values of a running Java process. As a result, a system effectively running under the root user is denied connection to a target Java process that is powered by the OpenJDK 8 on a Unix-like operating system if that process is running under another user.

One exemplary aspect of overcoming the shortcomings described above is to extend a system that is written in Java with a native library that provides handlers for native methods allowing to alter the current identity, or the EUID, EGID pair, of a process running the system. Suppose that the system is running under the root identity. The Java code comprising the system then invokes these native methods to adjust the current identity to match the identity of a target Java process after it has been determined, using the facilities of an underlying Unix-like operating system. One special consideration is to set the root user and the root group as the real user (RUID) and group (RGID) of the system before adjusting the current identity, which can drop the special privileges of the system. By doing so, it is possible to revoke the change and restore the lost privileges. The whole routine can then be repeated for another target Java process. Optionally, the Java processes that have been found with the facilities of the «com.sun.tools.attach» package may be grouped by the same identity to reduce the number of native method invocations required to handle all of them. One of the ways that such grouping may be carried out is using a hash table where keys are identities and values are lists of processes having the same identity.

On Linux, there are multiple kinds of user/group identifiers such as “real”, “effective”, and “saved-set”. The effective UID is what defines the permissions of a process within a Linux host. The real UID/GID represents the identity of a user who has launched the process. It is used by binaries such as “sudo” to determine what super-user actions the user is allowed to do. For instance, a user can be allowed to execute only specific commands as the root. It is decided by the “sudo” binary with the specific policies set by a system administrator. Saved-set UID/GIDs appear to matter in system calls that alter identities (“setuid”, “seteuid”). A program can temporarily save its true credentials in these parameters only to later restore them. But saved-set UID/GIDs are unfortunately very unstable as using inappropriate system calls (anything but “setresuid”) completely clobbers the saved values. Given that augmentation module 101 is not fully controlling the process environment, real UID/GIDs are relied upon. Accordingly, in the context of the current disclosure, the term “identity” means the pair of the effective UID/GID.

In order to determine the identity (e.g., the EUID, EGID pair) of a target Java process, the facilities which a Unix-like operating system provides may be used. For instance, on Linux, the file/proc/«pid»/status of a Java process with «pid» may be searched for a line starting with «Uid:» or «Gid:» prefixes. Such a line includes a space-separated list of integers each representing a certain identifier where the «Uid:» line shows values that the user identifiers of different kinds have for the Java process and the «Gid:» line reveals the same information for group identifiers. The effective identifier comes second in the list of integers in either case. As for the method of obtaining the process identifier, or «pid», of a Java process, the virtual machine descriptor of that process, which is stored in a list returned by the «list» method of the «com.sun.tools.attach.VirtualMachine» class, embeds data which helps to identify that process on a specific platform. In particular, on Unix, such a descriptor includes the process identifier of a Java process, which may be retrieved and used to locate the status file of that process.

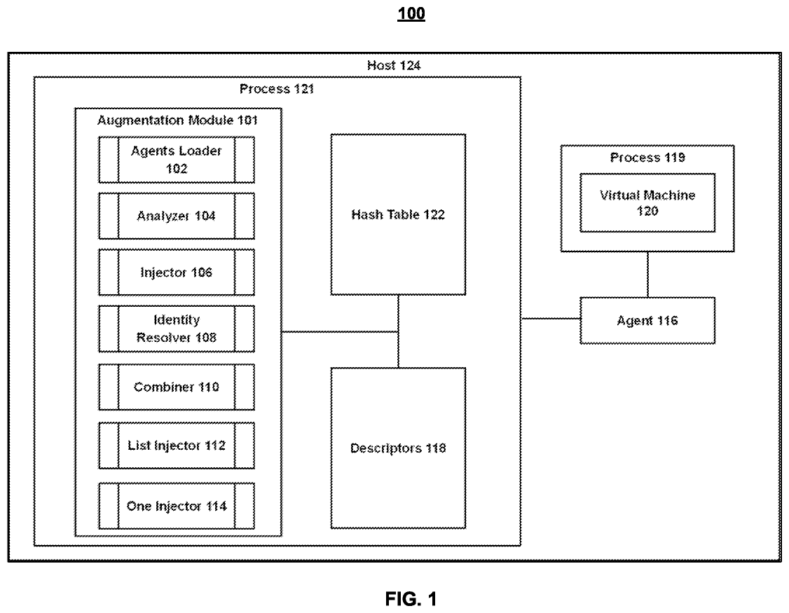

FIG. 1 is a block diagram illustrating system 100 for loading agents into virtual machines. System 100 includes augmentation module 101, which includes a plurality of components. The components include agents loader 102, analyzer 104, injector 106, identity resolver 108, combiner 110, list injector 112, and one injector 114. Augmentation module 101 is configured to load agent 116 into virtual machine 120 running on the common host 124.

Agents loader 102 is a core component that receives a path to a Java agent 116 and an options string from a user. Before the actual operation, this component checks whether the current OS process 121 is a privileged one because, otherwise, it may be impossible to change the current identity on some platforms. This may be done in native code in a supplementary library. An example of how to carry out such checks on the Unix platform is given below.

```
static bool selfChecks(JNIEnv *env) {
    const unsigned int theRoot = 0;
    struct {
      gid_t rGid;
      gid_t eGid;
    } myGroup;
    if (geteuid( ) != (uid_t) theRoot) {
      raiseInternalError(env,
        EACCES,
        _{——}func_{——},
        “not root”);
      return false;
    }
    myGroup.rGid = getgid( );
    myGroup.eGid = getegid( );
    if (setregid((gid_t) theRoot, (gid_t) theRoot) < 0) {
      raiseInternalError(env,
        errno,
        _{——}func_{——},
        “setregid”);
      return false;
    }
    if (setreuid((uid_t) theRoot, (uid_t) theRoot) < 0) {
      raiseInternalError(env,
        errno,
        _{——}func_{——},
        “setreuid”);
      setregid(myGroup.rGid, myGroup.eGid);
      return false;
    }
    return true;
  }
```

As mentioned earlier, on a Unix-like operating system, it is essential to set the real user and group identifiers to those of the root user. Failing to do so results in the inability to revoke a temporary replacement of the current identity to those of a target Java process 119 and restore the privileged identity. The given code extract also performs this. Similar precautions may be necessary for other platforms as well.

The remaining actions taken by agents loader 102 are to retrieve a list of descriptors 118 of attachable virtual machines (including virtual machine 120) with the «list» method of the «com.sun.tools.attach.VirtualMachine» class and coordinate other components to augment the found Java processes (e.g., process 119) with the specified Java agent 116.

Analyzer 104 groups lists of processes (including process 119) by identities. This component allocates a hash table 122 where keys are identities and values are lists of process identifiers. Analyzer 104 then handles elements of a provided list of descriptors 118 one by one, querying the identity of a Java process 119 with OS facilities and placing the identifier of that Java process 119 in the right place in the hash table 122. An example of the implementation of this component in Java is given below:

```
/*
  The following statements have been executed:
  List<VirtualMachineDescriptor> allVMs;
  allVMs = VirtualMachine.list( );
  */
HashMap<Identity, LinkedList<String>> ht;
ht = new HashMap<Identity, LinkedList<String>>( );
for (VirtualMachineDescriptor oneVM : allVMs) {
  String processId = oneVM.id( );
  Identity identity;
  if (processId.equals(MY_PROCESS_ID))
    continue;
  if ((identity = identityResolver(processId)) == null)
    continue;
  combiner(ht, processId, identity);
  }
```

An example of a hash table 122 is given below:

```
{
  “{ .userId = ‘geoclue’, .groupId = ‘geoclue’ }”: [
    35801
  ],
  “{ .userId = ‘_apt’, .groupId = ‘nogroup’ }”: [
    35777,
    35779
  ],
  “{ .userId = ‘lp’, .groupId = ‘lp’ }”: [
    35774,
    35775
  ],
  “{ .userId = ‘sys’, .groupId = ‘sys’ }”: [
    35793,
    35791
  ],
  “{ .userId = ‘avahi-autoipd’, .groupId = ‘avahi-autoipd’ }”: [
    35802,
    35782
  ],
  “{ .userId = ‘pulse’, .groupId = ‘pulse’ }”: [
    35785
  ],
  “{ .userId = ‘Debian-gdm’, .groupId = ‘Debian-gdm’ }”: [
    35780,
    35792
  ],
  “{ .userId = ‘speech-dispatcher’, .groupId = ‘audio’ }”: [
    35783,
    35794
  ],
  “{ .userId = ‘systemd-coredump’, .groupId = ‘systemd-coredump’ }”: [
    35796
  ],
  “{ .userId = ‘uucp’, .groupId = ‘uucp’ }”: [
    35781,
    35786,
    35795
  ],
  “{ .userId = ‘tss’, .groupId = ‘tss’ }”: [
    35798
  ],
  “{ .userId = ‘nobody’, .groupId = ‘nogroup’ }”: [
    35784,
    35803
  ],
  “{ .userId = ‘backup’, .groupId = ‘backup’ }”: [
    35797
  ],
  “{ .userId = ‘nikita’, .groupId = ‘nikita’ }”: [
    35799
  ],
  “{ .userId = ‘man’, .groupId = ‘man’ }”: [
    35800,
    35788
  ],
  “{ .userId = ‘rtkit’, .groupId = ‘rtkit’ }”: [
    35778
  ],
  “{ .userId = ‘messagebus’, .groupId = ‘messagebus’ }”: [
    35787
  ],
  “{ .userId = ‘colord’, .groupId = ‘colord’ }”: [
    35790
  ],
  “{ .userId = ‘bin’, .groupId = ‘bin’ }”: [
    35789,
    35776
  ]
}
```

In the example above, keys are identities and values are lists of (numeric) process identifiers for Java processes on a host. For clarity, effective user/group identifiers are represented by names, although it is sufficient for an actual implementation to deal with numeric values only. In an implementation, process identifiers are represented by strings, not integral numbers because this is how the Attach API gives them. Usually, these strings are string representations of the corresponding numbers.

Identity resolver 108 performs OS-specific actions to map a process 119 represented by its identifier onto an identity under which that process 119 is running. On Linux, this mapping may be carried out with data exported by «procfs». The implementation of this component demands special consideration. At some point during the execution of identity resolver 108, a fault can happen. This situation should be anticipated since the target process 119 may have exited thereby making all the data associated with it unavailable to the system managing Java agents. The implementation choice is to treat such a process as if it never existed.

Combiner 110 is a relatively small routine that fills the allocated hash table 122 with supplied parameters to achieve the desired grouping. An example of this routine is given by:

```
static private void combiner(HashMap<Identity, LinkedList<String>> ht,
      String processId,
      Identity identity) {
  LinkedList<String> processes = ht.get(identity);
  if (processes != null) {
    processes.add(processId);
  } else {
    processes = new LinkedList<String>( );
    processes.add(processId);
    ht.put(identity, processes);
  }
}
```

There are two guidelines related to combiner 110. The first is that the «Identity» class which defines objects embedding OS-specific information to distinguish identities must incorporate two special methods, namely «equals» and «hashCode», so that objects of this class may be used as keys inside hash tables. The second is that all objects in Java language are manipulated by references. This enables combiner 110, for instance, to alter a list of processes without modifying the associated hash table 122. The typical implementation of a hash table keeps references, or pointers, to objects without copying the very objects. So, it is possible to modify an object (in the disclosure, these objects are lists) without touching the hash table itself. Thus, the content of that hash table remains unchanged.

The exemplary way of implementing these special methods in the «Identity» class on Unix is demonstrated in the following code extract.

```
public class Identity {
  private int userId;
  private int groupId;
  public int getUserId( ) {
    return this.userId;
  }
  public int getGroupId( ) {
    return this.groupId;
  }
    ...
  public boolean equals(Object obj) {
    if (this == obj)
      return true;
    if (obj instanceof Identity) {
      Identity subj = (Identity) obj;
      return (subj.userId == this.userId &&
          subj.groupId == this.groupId);
    }
    return false;
  }
  public int hashCode( ) {
    return ((this.userId & 0xffff) *
        (this.groupId & 0x7fff));
  }
}
```

In a concrete implementation, list injector 112 is a component that may be inlined into injector 106, as demonstrated by the following code piece.

```
Set<Identity> allIdentities = ht.keySet( );
for (Identity identity : allIdentities) {
    LinkedList<String> processes = ht.get(identity);
    disguiseAsIdentity(identity.getUserId( ),
          identity.getGroupId( ));
    for (String processId : processes) {
      try {
        oneInjector(processId, jarPath, options);
      } catch (Exception exc) {
        ;
      }
    }
    disguiseAsIdentity(0, 0);
  }
```

In the snippet above, «disguiseAsIdentity» is a native method provided by the supplementary library. Its reference implementation on Unix is given below:

```
JNIEXPORT void JNICALL disguiseAsIdentity(JNIEnv *env, jclass cls,
jint userId, jint groupId)
{
    const unsigned int theRoot = 0;
    (void) cls;
    if (setregid((gid_t) theRoot, (gid_t) groupId) < 0) {
      raiseInternalError(env,
        errno,
        _{——}func_{——},
        “setregid”);
      return;
    }
    if (setreuid((uid_t) theRoot, (uid_t) userId) < 0) {
      raiseInternalError(env,
        errno,
        _{——}func_{——},
        “setreuid”);
      setregid((gid_t) theRoot, (gid_t) theRoot);
      return;
    }
  }
```

On the Unix platform, one precaution must be taken to alter the current group identifiers with «setregid» before modifying the current user identifiers with «setreuid» as doing the latter first drops the special privileges that the system has had, including the privilege to alter identity.

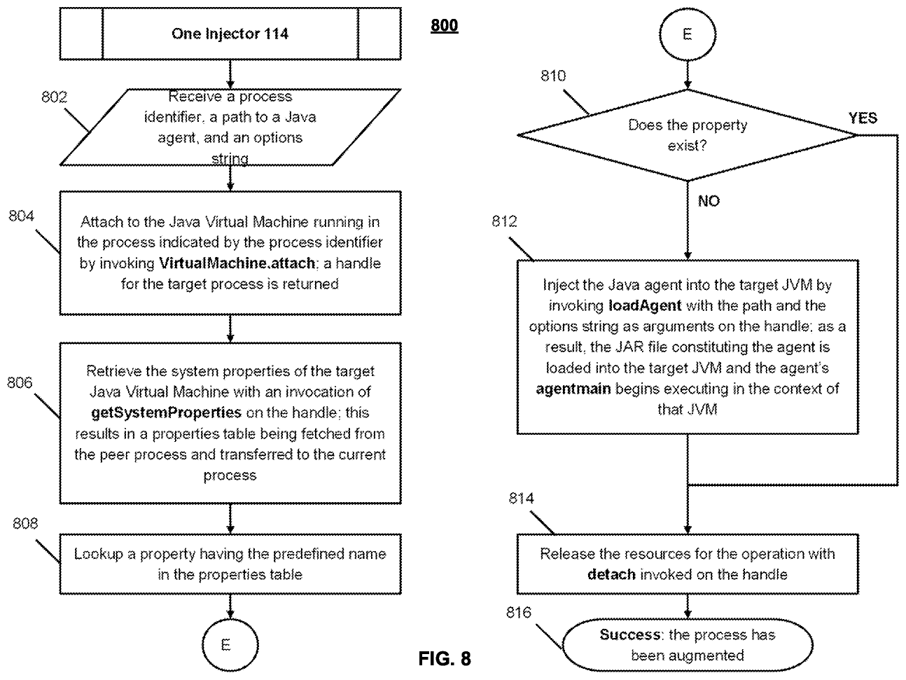

In the following example, the Java code constituting one injector 114 fully reproduces the logic of the corresponding flowchart drawn in FIG. 8.

```
  static private final String PROPERTY_NAME = “...”;
  static private void oneInjector(String processId,
          String jarPath,
          String options)
    throws Exception {
    VirtualMachine vmHandle = VirtualMachine.attach(processId);
    try {
      Properties vmProps;
      String propValue;
      vmProps = vmHandle.getSystemProperties( );
      propValue = vmProps.getProperty(PROPERTY_NAME);
      if (processId.equals(propValue)) {
        ;
      } else {
        vmHandle.loadAgent(jarPath, options);
      }
    } finally {
      try {
        vmHandle.detach( );
      } catch (IOException exc) {
        ;
      }
    }
}
```

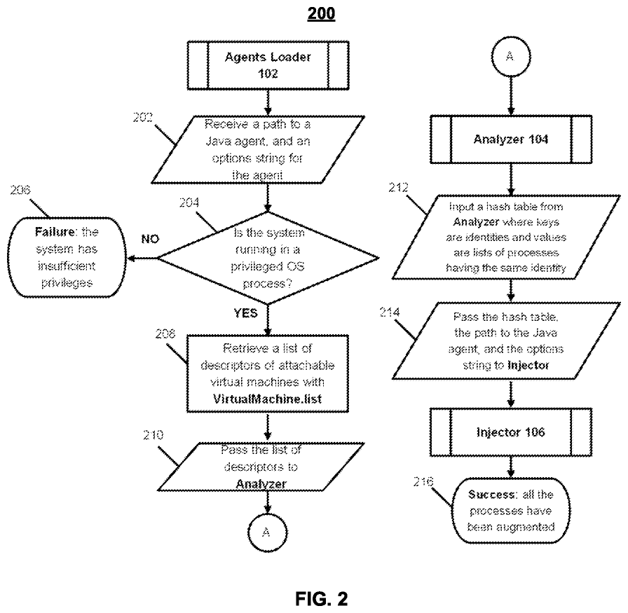

FIG. 2 illustrates a flow diagram 200 for loading agents into Java Virtual Machines coexisting on a system host. This component takes input from a user, then discovers JVM instances (e.g., virtual machine 120) currently running on the host (e.g., host 124), and, finally, uses other components to process the raw data and load a specified agent 116 into JVM instances that have not been affected yet.

At 202, agents loader 102 receives, from a user, a path to an agent 116 (e.g., a Java agent) and an options string for the agent 116. At 204, agents loader 102 determines whether it is running in a privileged operating system process (i.e., checks whether the current process 121 is a privileged one). More specifically, augmentation module 101 must ensure that it has enough privileges to adjust its own identity later. To achieve this, it checks if the process running the system (i.e., process 121) is owned by the root (effective UID=0). If not, diagram 200 ends at 206, where agents loader 102 indicates a failure due to the system having insufficient privileges. Otherwise, diagram 200 advances to 208, where agents loader 102 retrieves a list of descriptors 118 of attachable virtual machines (e.g., using VirtualMachine.list) including virtual machine 120. More specifically, the API function, which is tried by the system, uses a platform-specific way of determining JVM instances. It is all done on a request without any sort of subsequent caching. At 210, agents loader 102 passes the list of descriptors 118 to analyzer 104.

At 212, analyzer 104 populates a hash table 122 in which keys are identities and values are lists of processes having the same identity. At 214, agents loader 102 passes the hash table 122, the path to the agent 116, and the options string to injector 106. At 216, injector 106 augments all processes (including process 119). It should be noted that the interaction with the injector 106 resembles subroutine invocation where relations between caller and callee are strictly hierarchical.

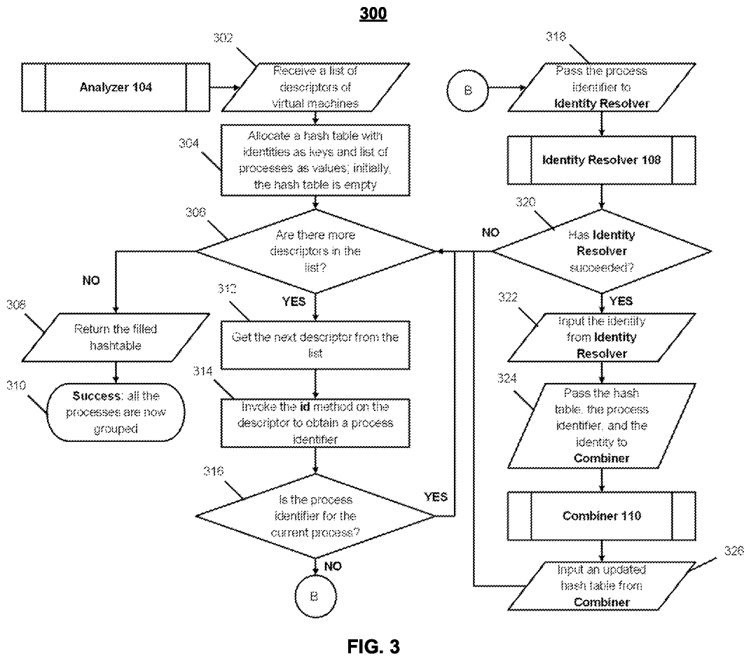

FIG. 3 illustrates a flow diagram 300 of an analyzer 104 configured to transform a list of descriptors 118 of virtual machines into a hash table 122 with identities as keys and lists of process identifiers as values. Such an aggregation helps in overcoming the shortcomings of OpenJDK 8, explained earlier in the disclosure, efficiently.

At 302, analyzer 104 receives a list of descriptors 118 of virtual machines. At 304, analyzer 104 allocates an empty hash table 122 of the specified layout. At 306, analyzer 104 enters a loop iterating through the descriptors from the list. Each iteration begins with testing if there is at least one descriptor in the list. If not, diagram 300 proceeds to 308, where analyzer 104 returns the filled hash table 122. At 310, all processes are grouped by identity. If there is a descriptor in the list, at 312, analyzer 104 retrieves it. At 314, analyzer 104 obtains a process identifier by invoking the id method on the descriptor. At 316, analyzer 104 determines whether the process identifier is for the current process 121. If the process identifier is for the current process 121, diagram 300 returns to 306. Otherwise, diagram 300 advances to 318, where analyzer 104 passes the process identifier to identity resolver 108. At 320, it is determined whether identity resolver 108 succeeded in resolving the identity of the process. If not, diagram 300 returns to 306. If yes, diagram 300 advances to 322, where identity resolver 108 outputs the identity. At 324, analyzer 104 passes the hash table 122, the process identifier, and the identity to combiner 110. At 326, analyzer 104 is in possession of an updated hash table 122 received from combiner 110. Here, combiner 110 has already added a new data point to the hash table 122 and semantically, analyzer 104 needs to retrieve the updated hash table (i.e., a hash table having the new data point along with the older ones) from combiner 110. In practice, however, no additional steps are needed since hash table 122 is an object in Java and it is passed to subroutines via reference. Diagram 300 then repeats the loop by returning to 306.

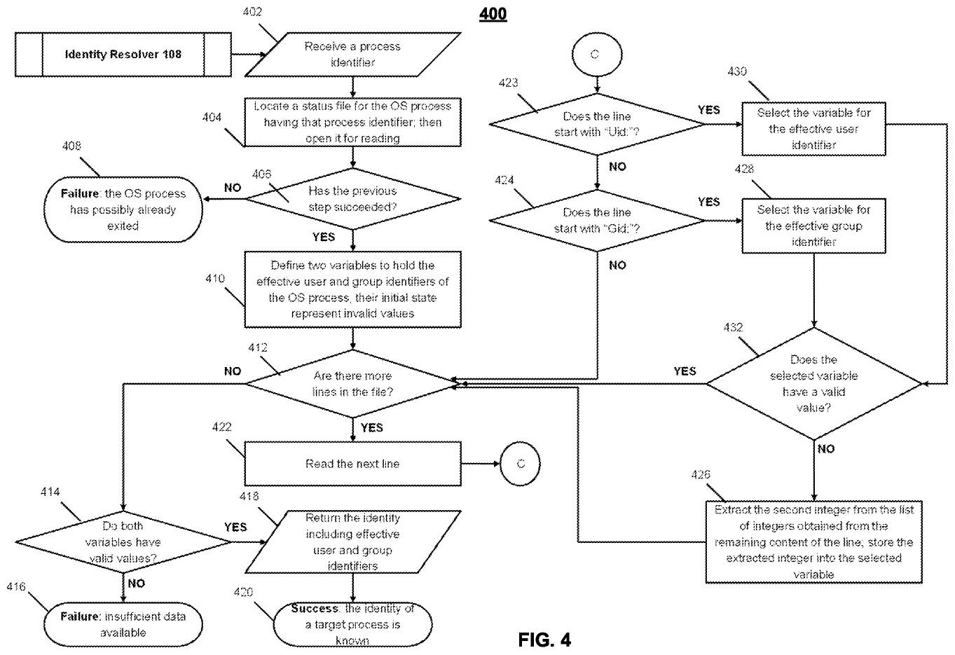

FIG. 4 illustrates a flow diagram 400 for mapping a process identifier onto an identity on the Linux platform. At 402, identity resolver 108 receives a process identifier. At 404, identity resolver 108 locates a status file for an OS process (e.g., process 119) having that process identifier and opens it for reading. More specifically, this is achieved by constructing the possible path of the status file. For instance, “/proc/1/status” represents the status file for the process with PID=1. The absence of a file at such a path signals that the corresponding process has exited. At 406, identity resolver 108 determines whether the status file was successfully located and opened. If not, diagram 400 ends at 408, with the conclusions that the OS process 119 has possibly already exited. Otherwise, diagram 400 proceeds to 410, where identity resolver 108 defines two variables to hold the effective user and group identifiers of the OS process 119, wherein their initial state represent invalid values.

At 412, identity resolver 108 determines whether there are more lines in the status file. If there are no more lines, diagram 400 proceeds to 414, where identity resolver 108 determines whether both variables have valid values. One of the possible ways to check for valid values is to initialize these variables with the unreal UID value (like −1). Then, at step 414 the value of a variable is tested for equality with −1. If there is a match, then an invalid UID/GID value is detected. If the values are invalid, diagram 400 ends at 416, where identity resolver 108 concludes that there is insufficient data available. If the values are valid, diagram 400 proceeds to 418, where identity resolver 108 returns the identity including the effective user and group identifiers. At 420, identity resolver 108 concludes that the identity of the target process 119 is known.

If, at 412, identity resolver 108 determines that there are more lines in the status file, diagram 400 enters a loop by advancing to 422, where identity resolver 108 reads the next line from the status file. At 423, identity resolver 108 determines whether the line starts with “Uid:”. If yes, at 430, identity resolver 108 selects the variable for the effective user identifier. Depending on a line prefix (“Uid:” or “Gid:”), the associated variable must be set to the value from the line. To do this, the variable is first selected using the prefix, then the numeric value of the effective UID/GID is extracted, and, finally, that value is assigned to one of the variables (i.e., the selected variable).

If not, diagram 400 advances to 424, where identity resolver 108 determines whether the line starts with “Gid:”. If yes, at 428, identity resolver 108 selects the variable for the effective group identifier. From 430 and 428, diagram 400 advances to 432, where identity resolver 108 determines whether the selected variable has already been set to a valid value by an earlier iteration of the loop. If yes, diagram 400 returns to 412, thereby proceeding to the next iteration of the loop. Determining that the line does not start with either prefix results in the same outcome. If, at 432, it is determined that the selected variable does not have a valid value, diagram 400 advances to 426, where identity resolver 108 extracts the second integer from a list of integers obtained from the remaining content of the line and stores the extracted integer into the selected variable. The next iteration of the loop then starts with a repeat check at 412.

An example of a status file is given below:

| Name: | systemd | |
|---|---|---|
| Umask: | 0000 | |
| State: | S (sleeping) | |
| Tgid: | 1 | |
| Ngid: | 0 | |
| Pid: | 1 | |
| PPid: | 0 | |
| TracerPid: | 0 | |
| Uid: | 0 0 0 0 | |
| Gid: | 0 0 0 0 | |
| FDSize: | 256 | |
| Groups: | | |
| NStgid: | 1 | |
| NSpid: | 1 | |
| NSpgid: | 1 | |
| NSsid: | 1 | |
| VmPeak: | 233136 | kB |
| VmSize: | 168068 | kB |
| VmLck: | 0 | kB |
| VmPin: | 0 | kB |
| VmHWM: | 12664 | kB |
| VmRSS: | 10896 | kB |
| RssAnon: | 3472 | kB |
| RssFile: | 7424 | kB |
| RssShmem: | 0 | kB |
| VmData: | 19300 | kB |
| VmStk: | 132 | kB |
| VmExe: | 40 | kB |
| VmLib: | 10652 | kB |
| VmPTE: | 84 | kB |
| VmSwap: | 0 | kB |
| HugetIbPages: | 0 | kB |

| CoreDumping: | 0 |
|---|---|
| THP_enabled: | 1 |
| Threads: | 1 |
| SigQ: | 1/30544 |
| SigPnd: | 0000000000000000 |
| ShdPnd: | 0000000000000000 |
| SigBlk: | 7fe3c0fe28014a03 |
| SigIgn: | 0000000000001000 |
| SigCgt: | 00000001000004ec |
| CapInh: | 0000000000000000 |
| CapPrm: | 000001ffffffffff |
| CapEff: | 000001ffffffffff |
| CapBnd: | 000001ffffffffff |
| CapAmb: | 0000000000000000 |
| NoNewPrivs: | 0 |
| Seccomp: | 0 |
| Seccomp_filters: | 0 |
| Speculation_Store_Bypass: | thread vulnerable |
| SpeculationIndirectBranch: | conditional enabled |
| Cpus_allowed: | ff |
| Cpus_allowed_list: | 0-7 |
| Mems_allowed: | 00000000, 00000000, 00000000, |
| | 00000000, 00000000, 00000000, |
| | 00000000, 00000000, 00000000, |
| | 00000000, 00000000, 00000000, |
| | 00000000, 00000000, 00000000, |
| | 00000000, 00000000, 00000000, |
| | 00000000, 00000000, 00000000, |
| | 00000000, 00000000, 00000000, |
| | 00000000, 00000000, 00000000, |
| | 00000000, 00000000, 00000000, |
| | 00000000, 00000001 |
| Mems_allowed_list: | 0 |
| voluntary_ctxt_switches: | 5334 |
| nonvoluntary_ctxt_switches: | 156 |

As seen from the example, only the lines prefixed by “Uid:” or “Gid:” feature the list of four integral numbers.

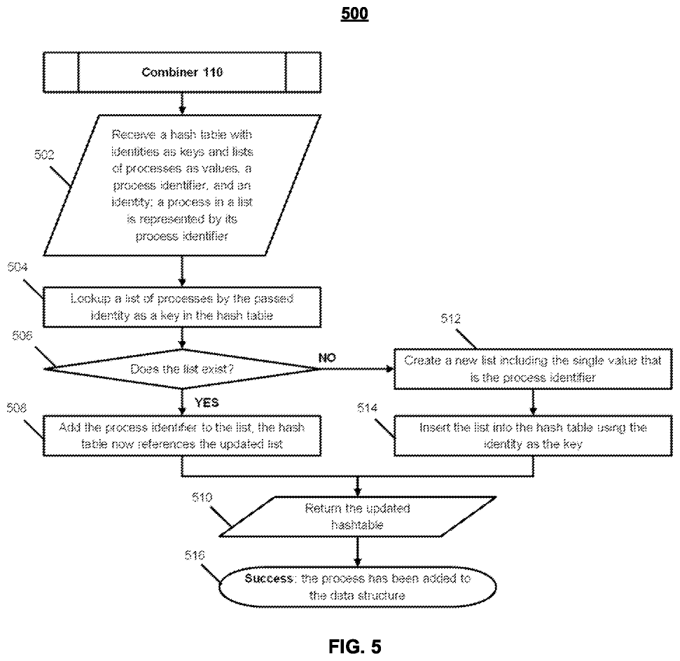

FIG. 5 illustrates a flow diagram 500 for adding a pair including a process identifier and an identity into the hash table 122. At 502, combiner 110 receives a hash table 122 with identities as keys and lists of processes as values, a process identifier, and an identity; a process in a list is represented by its process identifier. At 504, combiner 110 performs a lookup of a list of processes by the passed identity as a key in the hash table 122. At 506, combiner 110 determines whether the list exists. If not, at 512, combiner 110 creates a new list including the single value that is the process identifier. At 514, combiner 110 inserts the list into the hash table 122 using the identity as the key.

If, at 506, combiner 110 determines that the list exists, diagram 500 advances to 508, where combiner 110 adds the process identifier to the list such that the hash table 122 now references the updated list. From 508 and 514, diagram 500 advances to 510, where combiner 110 returns the updated hash table 122. At 516, the process has been added to the data structure.

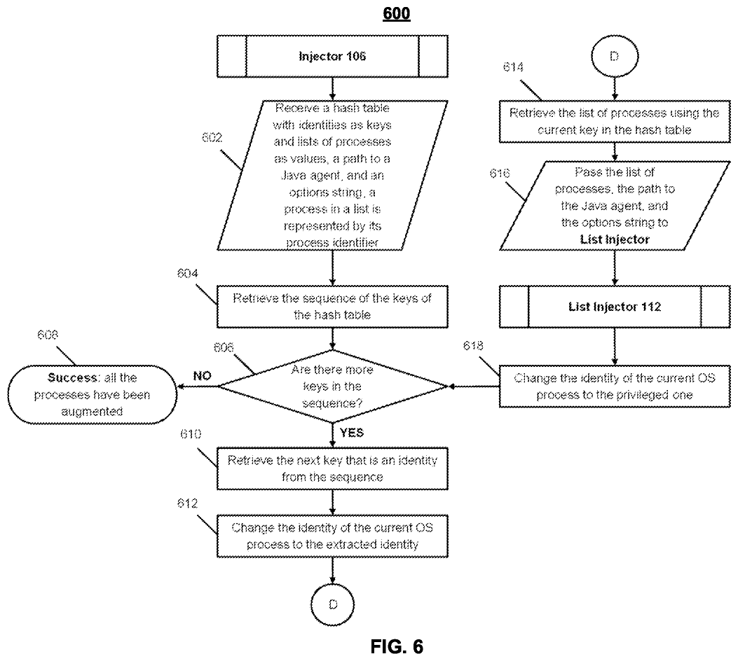

FIGS. 6 to 8 depict constituent parts of an agent loading component. More specifically, FIG. 6 illustrates a flow diagram 600 of an upper layer of the agent loading component. The upper layer iterates through identities. For each identity, this layer disguises the system managing Java agents as running under that identity, invokes the next layer to handle all Java processes mapped onto that same identity, and reinstates the privileged identity.

At 602, injector 106 receives a hash table 122 with identities as keys and lists of processes as values, a path to a Java agent 116, and an options string; a process in a list is represented by its process identifier. At 604, injector 106 retrieves the sequence of the keys of the hash table 122. At 606, injector 106 determines whether there are more keys in the sequence. If not, diagram 600 ends at 608 (i.e., all processes have been augmented). Otherwise, diagram 600 advances to 610, where injector 106 gets the next key that is an identity from the sequence. At 612, injector 106 changes the identity of the current OS process 121 to the extracted identity. At 614, injector 106 gets the list of processes using the current key in the hash table 122. At 616, injector 106 passes the list of processes, the path to the Java agent 116, and the options string to list injector 112. At 618, injector 106 changes the identity of the current OS process 121 to the privileged one. Subsequently, diagram 600 returns to 606.

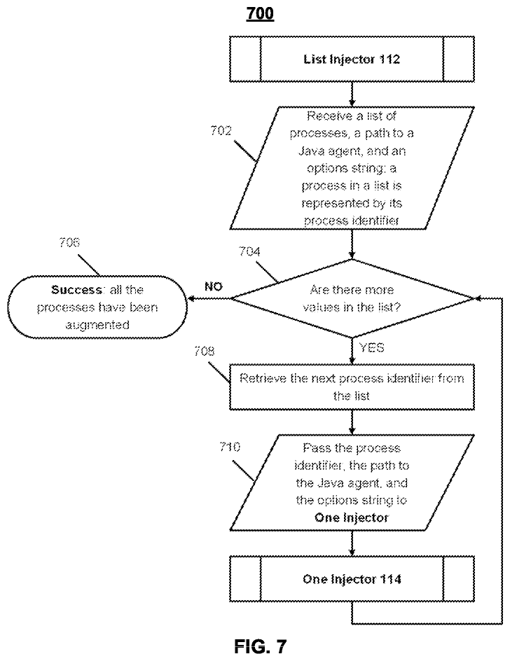

FIG. 7 illustrates a flow diagram 700 of a middle layer of the agent loading component. This layer invokes the bottom layer for each Java process in a list. At 702, list injector 112 receives a list of processes, a path to a Java agent 116, and an options string; a process in a list is represented by its process identifier. At 704, list injector 112 determines whether there are more values in the list. If not, diagram 700 ends at 706 (i.e., all processes have been augmented). Otherwise, diagram 700 advances to 708, where list injector 112 gets the next process identifier from the list. At 710, list injector 112 passes the process identifier, the path to the Java agent 116, and the options string to one injector 114. Subsequently, diagram 700 returns to 704.

FIG. 8 illustrates a flow diagram 800 of a bottom layer of the agent loading component. This layer implements the logic of testing if a Java process 119 already has the given Java agent 116 loaded and injecting this agent 116 into that process otherwise.

At 802, one injector 114 receives a process identifier, a path to a Java agent 116, and an options string. At 804, one injector 114 attaches to the Java Virtual Machine 120 running in the process 119 indicated by the process identifier by invoking VirtualMachine.attach and a handle for the target process 119 is returned. At 806, one injector 114 retrieves the system properties of the target Java Virtual Machine 120 with an invocation of getSystemProperties on the handle; this results in a properties table being fetched from the peer process 119 and transferred to the current process 121. At 808, one injector 114 performs a lookup of a property having the predefined name in the properties table.

At 810, one injector 114 determines whether the property exists. If not, at 812, one injector 114 injects the Java agent 116 into the target JVM 120 by invoking loadAgent with the path and the options string as arguments on the handle. As a result, the JAR file constituting the agent 116 is loaded into the target JVM 120 and the agent's agentmain begins executing in the context of that JVM. From there, diagram 800 proceeds to 814.

Likewise, if at 810 one injector 114 determines that the property exists, diagram 800 proceeds to 814. At 814, one injector 114 releases the resources for the operation with detach invoked on the handle. At 816, the process 119 has been augmented.

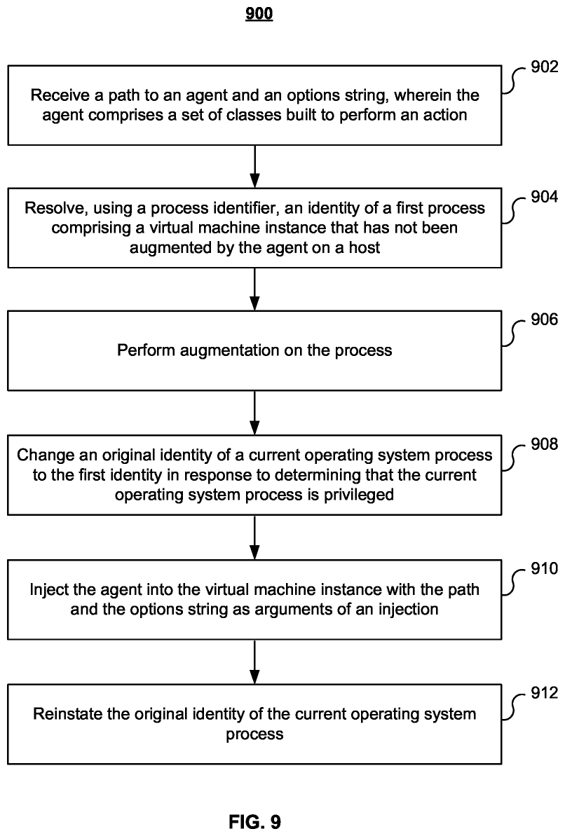

FIG. 9 is a flow diagram illustrating a method 900 for loading agents into virtual machines. At 902, augmentation module 101 receives a path to an agent (e.g., agent 116) and an options string, wherein the agent comprises a set of classes built to perform an action. At 904, augmentation module 101 resolves, using a process identifier, an identity of a first process (e.g., process 119) comprising a virtual machine instance (e.g., virtual machine 120) that has not been augmented by the agent on a host. At 906, augmentation module 101 performs augmentation on the process. This involves performing the following actions. At 908, augmentation module 101 changes an original identity of a current operating system process (e.g., process 121) to the first identity in response to determining that the current operating system process is privileged. At 910, augmentation module 101 injects the agent into the virtual machine instance with the path and the options string as arguments of an injection. At 912, augmentation module 101 reinstates the original identity of the current operating system process.

In some aspects, resolving the identity comprises retrieving a status file associated with the process identifier and parsing the status file to determine an effective user identifier and an effective group identifier, wherein the first identity comprises the effective user identifier and the effective group identifier.

In some aspects, augmentation module 101 identifies the virtual machine instance by retrieving a list of virtual machine descriptors (e.g., descriptors 118) wherein each descriptor designates a process running a virtual machine (e.g., virtual machine 120). Augmentation module 101 identifies the virtual machine instance in the list.

In some aspects, augmentation module 101 performs the augmentation on the process by executing a Java attach mechanism.

In some aspects, augmentation module 101 determines whether the current operating system process is privileged. Augmentation module 101 sets a real user identifier and a group identifier to those of a root user to facilitate subsequent dropping and restoring of the privilege.

In some aspects, the first identity belongs to both the first process and a second process. Augmentation module 101 populates a hash table (e.g., hash table 122) comprising the first identity and process identifiers for the first process and the second process, wherein keys of the hash table are identities and values of the hash table are lists of process identifiers. Augmentation module 101 groups the first process and the second process based on matching identities.

In some aspects, augmentation module 101 queries a respective identity of each process with operating system facilities, and places a respective identifier of each process in the hash table.

In some aspects, augmentation module 101 defines objects embedding operating system-specific information to distinguish identities, uses the objects as keys inside hash tables, and alters a list of processes without modifying the hash table.

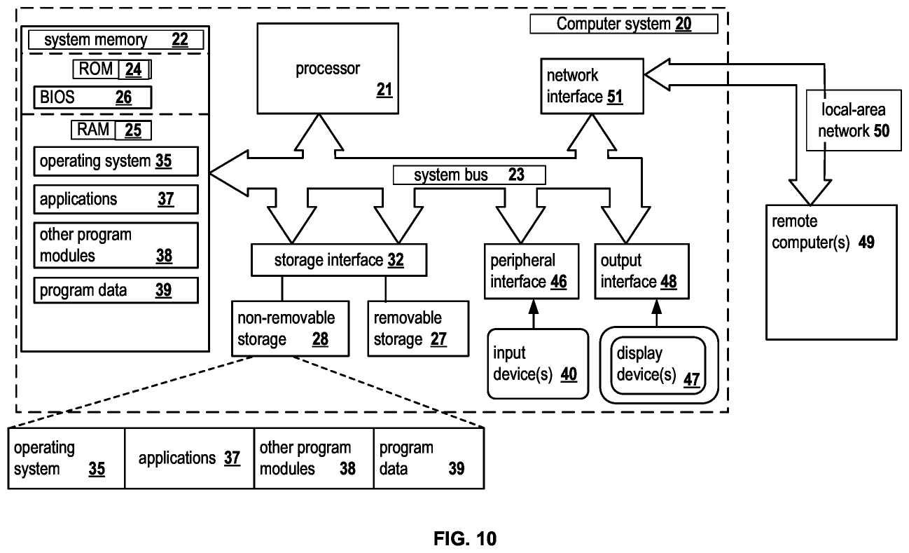

FIG. 10 is a block diagram illustrating a computer system 20 on which aspects of systems and methods for loading agents into virtual machines may be implemented in accordance with an exemplary aspect. The computer system 20 may be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of the commands/steps discussed in FIGS. 1-9 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which may be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium may be a tangible device that can retain and store program code in the form of instructions or data structures that may be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein may be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure may be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method of loading an agent into a virtual machine, the method comprising:
receiving a path to an agent and an options string, wherein the agent comprises a set of classes built to perform an action;
resolving, using a process identifier, an identity of a first process comprising a virtual machine instance that has not been augmented by the agent on a host;
performing augmentation on the process by:
changing an original identity of a current operating system process to the first identity in response to determining that the current operating system process is privileged;
injecting the agent into the virtual machine instance with the path and the options string as arguments of an injection;
reinstating the original identity of the current operating system process.

2. The method of claim 1, wherein resolving the identity comprises:
retrieving a status file associated with the process identifier;
parsing the status file to determine an effective user identifier and an effective group identifier, wherein the first identity comprises the effective user identifier and the effective group identifier.

3. The method of claim 1, further comprising identifying the virtual machine instance by:
retrieving a list of virtual machine descriptors wherein each descriptor designates a process running a virtual machine; and
identifying the virtual machine instance in the list.

4. The method of claim 1, wherein performing the augmentation on the process comprises executing a Java attach mechanism.

5. The method of claim 1, further comprising:
determining that the current operating system process is privileged;
setting a real user identifier and a group identifier to those of a root user to facilitate subsequent dropping and restoring of the privilege.

6. The method of claim 1, wherein the first identity belongs to both the first process and a second process, further comprising:
populating a hash table comprising the first identity and process identifiers for the first process and the second process, wherein keys of the hash table are identities and values of the hash table are lists of process identifiers;
grouping the first process and the second process based on matching identities.

7. The method of claim 6, further comprising:
querying a respective identity of each process with operating system facilities; and
placing a respective identifier of each process in the hash table.

8. The method of claim 7, further comprising:
defining objects embedding operating system-specific information to distinguish identities;
using the objects as keys inside hash tables; and
altering a list of processes without modifying the hash table.

9. A system for loading an agent into a virtual machine, comprising:
at least one memory;
at least one hardware processor coupled with the at least one memory and configured, individually or in combination, to:
receive a path to an agent and an options string, wherein the agent comprises a set of classes built to perform an action;
resolve, using a process identifier, an identity of a first process comprising a virtual machine instance that has not been augmented by the agent on a host;
perform augmentation on the process by:
changing an original identity of a current operating system process to the first identity in response to determining that the current operating system process is privileged;
injecting the agent into the virtual machine instance with the path and the options string as arguments of an injection;
reinstating the original identity of the current operating system process.

10. The system of claim 9, wherein the at least one hardware processor is configured to resolve the identity by:
retrieving a status file associated with the process identifier;
parsing the status file to determine an effective user identifier and an effective group identifier, wherein the first identity comprises the effective user identifier and the effective group identifier.

11. The system of claim 9, wherein the at least one hardware processor is further configured to identify the virtual machine instance by:
retrieving a list of virtual machine descriptors wherein each descriptor designates a process running a virtual machine; and
identifying the virtual machine instance in the list.

12. The system of claim 9, wherein the at least one hardware processor is configured to perform the augmentation on the process by executing a Java attach mechanism.

13. The system of claim 9, wherein the at least one hardware processor is configured to:
determine that the current operating system process is privileged;
set a real user identifier and a group identifier to those of a root user to facilitate subsequent dropping and restoring of the privilege.

14. The system of claim 9, wherein the first identity belongs to both the first process and a second process, wherein the at least one hardware processor is configured to:
populate a hash table comprising the first identity and process identifiers for the first process and the second process, wherein keys of the hash table are identities and values of the hash table are lists of process identifiers;
group the first process and the second process based on matching identities.

15. The system of claim 14, wherein the at least one hardware processor is configured to:
query a respective identity of each process with operating system facilities; and
place a respective identifier of each process in the hash table.

16. The system of claim 15, wherein the at least one hardware processor is configured to:
define objects embedding operating system-specific information to distinguish identities;
use the objects as keys inside hash tables; and
alter a list of processes without modifying the hash table.

17. A non-transitory computer readable medium storing thereon computer executable instructions for loading an agent into a virtual machine, including instructions for:
receiving a path to an agent and an options string, wherein the agent comprises a set of classes built to perform an action;
resolving, using a process identifier, an identity of a first process comprising a virtual machine instance that has not been augmented by the agent on a host;
performing augmentation on the process by:
changing an original identity of a current operating system process to the first identity in response to determining that the current operating system process is privileged;
injecting the agent into the virtual machine instance with the path and the options string as arguments of an injection;
reinstating the original identity of the current operating system process.
